(19) United States
(12) Patent Application Publication
(10) Pub. No.: US 2020/0407598 A1
(43) Pub. Date: Dec. 31, 2020

(54) Pleated, Waterproof Sealing Tape and Method of Use

(71) Applicant: Gardner-Gibson, Inc, Tampa, FL (US)

(72) Inventors: Prabani Dissanayake, Wesley Chapel, FL (US); Lirije Kabashi, New Port Richey, FL (US); Amir Khan, Lutz, FL (US); Sean Hyer, Tampa, FL (US)

(21) Appl. No.: 16/871,360

(22) Filed: May 11, 2020

Related U.S. Application Data
(60) Provisional application No. 62/845,429, filed on May 9, 2019.

(51) Int. Cl. C09J 7/22; C09J 7/38; C09J 7/29

(52) U.S. Cl. CPC C09J 7/22; C09J 7/29; C09J 7/383; C09J 7/385

(57) ABSTRACT

The present invention relates to a pleated sealing tape for providing a waterproof covering. The pleated sealing tape includes a flexible sheet made of a polymeric material and having a plurality of pleats extending from a first end of the sheet to an opposing end of the sheet. The pleated sealing tape also has a front surface and a rear surface, and the rear surface of the sheet includes a pressure-sensitive adhesive. When the sheet is applied to a surface, the sheet is configured to be removed by stretching the sheet in a direction transverse to the orientation of the plurality of pleats and subsequently peeling the sheet off of the surface.

### CROSS REFERENCE TO RELATED APPLICATION

This application claims the benefit under 35 U.S.C. § 119(e) to U.S. Provisional Patent Application Ser. No. 62/845,429, filed May 9, 2019, and entitled “Pleated, Waterproof Sealing Tape and Method of Use”, the entire disclosure of which is incorporated herein by reference.

### BACKGROUND OF THE INVENTION

The present invention relates to a pleated sealing tape. Specifically, the present invention relates to a pleated sealing tape that can be applied to one or more surfaces to cover a gap defined by or between the surfaces in order to prevent liquids, moisture or debris from passing through the gap, and which can be easily applied and removed without damaging or leaving a residue on the surfaces.

In the event of a hurricane, storm, or other extreme weather event, it is often necessary to take precautionary measures to protect the windows and doors of buildings, such as homes, offices, shops, apartment buildings and the like. Strong winds can hurl debris, dirt, sand, and the like into the window or door, damaging or breaking the same. Additionally, exposure to heavy amounts of rainfall can damage the wooden frame of the window or door and may also cause moisture to leak inside the home. As a result, the window and door frames may suffer from water damage, and the moisture may increase the risk of mold formation.

Storm panels or storm shutters, referred to herein simply as “storm covers,” are often positioned over windows and doors to cover the same and protect the window or door from direct impact by water and debris. Storm covers are composed of various materials including plywood, plastic such as polycarbonate, or metal such as a corrugated aluminum or corrugated steel. The storm covers provide a solid barrier that can resist impact from debris while also limiting the exposure of the door or window to water.

While storm covers can limit the exposure of the window or door to liquid and debris, storm covers are generally not installed such that they form a watertight seal around the window or door. Instead, when the storm covers are installed, there is a seam or gap formed between the edge of the storm cover and the portion of the building to which it is connected. Even if the seam or gap is relatively small, over time strong winds and rainfall can cause a considerable amount of water, and fine debris such as sand or dirt to pass by the storm cover and contact the door or window.

In order to prevent water and debris from passing through the seam or gap around the storm cover, adhesive tapes, such as duct-tape and the like, are often applied around the perimeter of the storm cover to seal the gap between the storm cover and the building. However, conventional adhesive tapes are not specially designed to withstand continuous and prolonged exposure to rain and moisture and are not likely to be able to maintain their integrity and sealing ability in such conditions. Further, conventional adhesive tapes may be composed at least partially of cloth or canvas and as a result may not be sufficiently waterproof so as to prevent liquid from passing therethrough.

Conventional adhesive tapes may also have the drawback of being difficult to remove. The adhesive tape may tear or rip when attempts are made to remove the tape, leaving pieces of tape on the surface. Further, removing the tape may cause damage to the underlying surface, such as by peeling off paint or other surface finishes. The tape may also leave a sticky residue from the adhesive on the building and/or storm cover. The building and storm cover must be cleaned to remove the adhesive residue, which may require the use of commercial cleaning solutions. Cleaning the residue may be time consuming and expensive, and the cleaning process may also cause damage to the paint or finishing of the surface.

Thus, an improved sealing tape is desired that can be used to cover a gap or seam between surfaces that is waterproof and can be easily applied and removed without leaving a residue on a surface.

### BRIEF SUMMARY OF THE INVENTION

The present invention relates to a pleated sealing tape for providing a waterproof and/or water shedding covering, comprising: a flexible sheet comprising a polymeric material and having a plurality of pleats extending from a first end of the sheet to an opposing end of the sheet, and further comprising a front surface and a rear surface, wherein the rear surface of the sheet comprises a pressure-sensitive adhesive, and wherein when the sheet is applied to a surface, the sheet is configured to be removed by stretching the sheet in a direction transverse to the orientation of the plurality of pleats and subsequently peeled off of the surface.

The flexible sheet of the pleated sealing tape preferably has a thickness of about 0.02 mm to about 2 mm. Further, the polymeric material of the sheet may be selected from polyethylene, polyvinylchloride, polypropylene, polyurethane, and acrylonitrile-butadiene styrene (ABS).

The plurality of pleats of the pleated sealing tape are each preferably substantially parallel to a longitudinal axis of the flexible sheet. The plurality of pleats may be separated by an interval of about 0.025 cm to about 4.0 cm.

The rear surface of the sheet may have a plurality of peaks formed by the plurality of pleats with the pressure-sensitive adhesive applied to the plurality of peaks. The pressure-sensitive adhesive may comprise a natural rubber, a vinyl ether, an acrylic, butyl rubber, a styrene block copolymer, a silicone or a nitrile. Further, the front surface of the sheet may comprise a coating. In some embodiments, the sheet may comprise two or more layers.

The present invention also relates to a method for temporarily covering a gap formed between two surfaces, comprising providing a pleated sealing tape comprising a flexible sheet that comprises a polymeric material and a plurality of pleats extending from a first end of the sheet to an opposing end of the sheet, and further comprising a front surface and a rear surface, wherein the rear surface of the sheet comprises a pressure-sensitive adhesive, positioning the pleated sealing tape over a gap defined between two surfaces, and affixing the pleated sealing tape to the two surfaces defining the gap to secure the pleated sealing tape to the surfaces.

The method for temporarily covering a gap formed between two surfaces may further include affixing the pleated sealing tape to the two surfaces by pressing the rear surface of the pleated sealing tape into contact with the two surfaces.

In a preferred embodiment, the method further includes removing the pleated sealing tape by stretching the pleated sealing tape in a direction transverse to the orientation of the plurality of pleats and peeling the pleated sealing tape away from the two surfaces in a direction transverse to the orientation of the plurality of pleats.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a perspective view of a pleated sealing tape according to the present invention.

FIG. 2 is a top elevational view of the pleated sealing tape according to FIG. 1.

FIG. 3 is a transverse cross sectional view of a pleated sealing tape having a coating on the front surface of the sheet.

FIG. 4 is a perspective view of the pleated sealing tape in use to cover a gap between a storm cover and a building.

FIG. 5 is a transverse cross sectional view of the pleated sealing tape as used to cover a gap.

FIG. 6 is a transverse cross sectional view of the pleated sealing tape of FIG. 5 in a stretched configuration.

FIG. 7 is a transverse cross sectional view of the pleated sealing tape of FIG. 6 partially removed.

FIG. 8 is a transverse cross sectional view of an alternate embodiment of the pleated sealing tape having multiple layers.

### DETAILED DESCRIPTION OF THE INVENTION

The present invention relates to a pleated sealing tape that can be used to cover a gap or seam defined by or between two or more surfaces. The pleated sealing tape is particularly suited for use in applications where it is desired to prevent liquid, moisture or debris from entering the seam or gap. For example, the pleated sealing tape can be used to seal a gap or seam between a storm cover and a surface of a building to which the storm cover is applied so as to prevent liquid and debris from passing through the gap. While the present application is described as used to seal a gap formed between a surface of a building and a storm cover, this environment is merely illustrative and is not intended to be limiting. The pleated sealing tape of the present invention can be used in any of various applications requiring a sealing tape used to cover a gap or seam defined by or between one or more surfaces. For example, the pleated sealing tape of the present invention may also be useful in boating or marine applications, such as to temporarily seal gaps or seams around the perimeter of a boat's cabin door or windows. The pleated sealing tape can also be useful to seal the lid of a storage container to prevent liquid from entering the container, such as during rainfall. Further, while the pleated sealing tape is particularly useful in providing a waterproofing effect, the pleated sealing tape can be used in any of various applications in which conventional tapes are used.

The pleated sealing tape of the present invention may be designed for a single use. The pleated sealing tape can be applied to temporarily cover and seal a gap or seam, such as prior to a storm or hurricane. Once the storm is over, or the pleated sealing tape is otherwise no longer needed, the pleated sealing tape can be easily removed and subsequently disposed of. The pleated sealing tape can be removed without damaging the underlying surface to which it is applied and does not leave a significant adhesive residue on the surface.

The pleated sealing tape is described herein as being substantially “waterproof,” which indicates that little to no liquid, such as water, is able to permeate through the pleated sealing tape. While preferred, it is not required that the pleated sealing tape be completely waterproof, so long as liquid is not readily absorbed by and does not readily pass through the pleated sealing tape. The pleated sealing tape of the present invention is not intended for use in submerged applications, such as to cover a seam or gap in a portion of a building that may be submerged during a flood for long durations, or to patch a crack in a wall of a pool or bathtub.

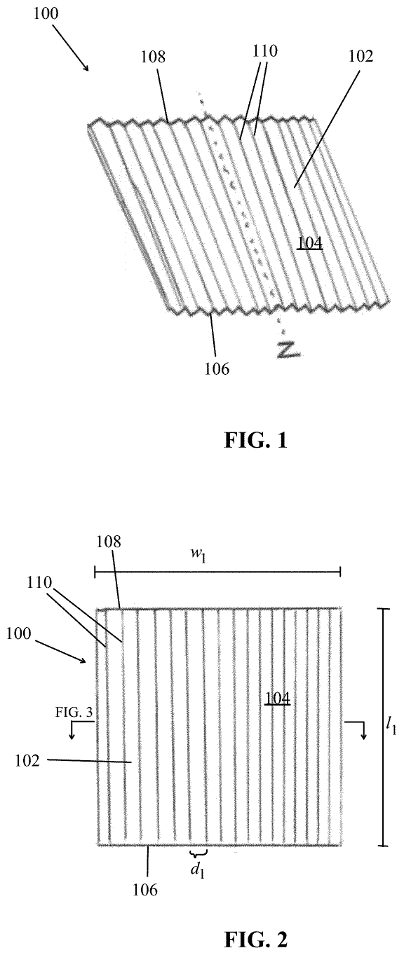

Referring now to FIGS. 1 and 2, there are shown views of an embodiment of the pleated sealing tape according to the present invention. The pleated sealing tape 100 of the present invention includes a flexible sheet 102. Preferably, the flexible sheet 102 is provided in a square or rectangular shape, as shown. However, the sheet 102 may be formed in any of various shapes. The sheet 102 has a length, l₁, measured along a longitudinal axis Z of the sheet 102, and a width, w₁, measured in a direction transverse to the longitudinal axis Z. The sheet 102 preferably has a uniform thickness measured as the shortest distance through the sheet 102 from a front surface 104 of the sheet 102 to a rear surface thereof.

The sheet 102 is sufficiently thick so that it is not easily torn or ripped, such as when impacted by debris. However, if the thickness is too great, the sheet may become too stiff, making it more difficult to form pleats may be more difficult, and increasing both the weight of the sheet and cost of materials used to produce the pleated sealing tape. Further, a person having ordinary skill in the art will appreciate that the thickness of the sheet may depend on the material selected to provide the required impact resistance and strength while maintaining flexibility. In some embodiments, the thickness of the sheet is preferably about 0.02 mm to about 2 mm or about 0.05 mm to about 1 mm.

The sheet 102 is formed with a plurality of pleats 110. The pleats 110 preferably extend from a first end 106 of the sheet 102 to an opposing, second end 108 of the sheet 102. The plurality of pleats 110 are preferably substantially parallel to one another and are parallel to the longitudinal axis Z of the sheet 102. The pleats 110 are preferably formed on the sheet 102 at a regular interval, d₁. The interval, d₁, may be about 0.025 cm to about 0.4 cm. In a preferred embodiment, the interval is about 0.1 cm. The pleats 110 need not be spaced at a regular and fixed interval, and successive pleats 110 may be separated at various intervals, wherein the various intervals are in the range of about 0.025 cm to about 0.4 cm.

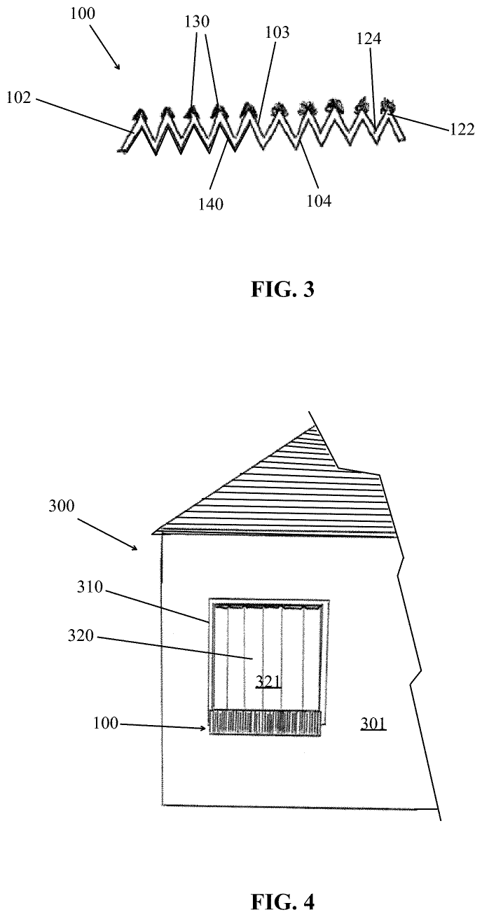

Referring now to FIG. 3, there is shown a transverse cross sectional view of the pleated sealing tape of FIG. 1. At rest, the pleated sealing tape 100 is in an unstretched configuration, such that the plurality of pleats 110 forms peaks 122 and troughs 124. The pleated sealing tape 100 is able to be stretched in a direction that is transverse to the longitudinal axis Z of the sheet 102 and transverse to the orientation of the pleats 110 so that when stretched, the width dimension of the pleated sealing tape 100 extends, and the peaks 122 flatten. When in a fully stretched configuration, the pleated sealing tape 100 flattens and is substantially planar.

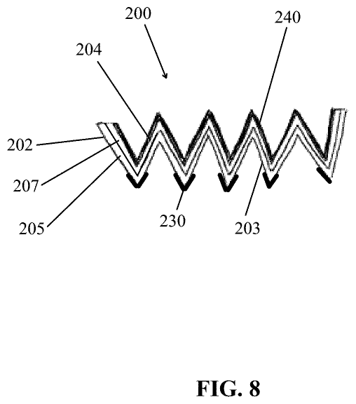

In a preferred embodiment, the sheet 102 is formed as a single layer, as shown in FIG. 3. However, in an alternate embodiment, the sheet 102 may have two or more layers, as shown for example at FIG. 8. The layers are preferably bonded to one another so as to form a unitary sheet 202. In FIG. 8, the sheet 202 is shown as having a first layer 205 and a second layer 207. The layers may be formed of the same material or different materials. The first layer 205 defines the rear surface 203 of the sheet 202 and the second layer 207 defines the front surface 204 of the sheet 202. For example, the first layer may be a material that provides improved strength properties or that demonstrates improved compatibility with an adhesive applied thereto, while the second layer 207 may provide a waterproofing effect.

The sheet 102 of the pleated sealing tape 100 may be formed of a material that is flexible and substantially waterproof, and is preferably formed of a polymeric material. The polymeric material may be polyethylene, including high-density and low-density polyethylene, polyvinylchloride, polypropylene, polyurethane, and acrylonitrile-butadiene-styrene (ABS), SIS-based adhesives, HC resin adhesives, mineral oils, CA and/or CI tack resins, among others. Preferably, the material is also resistant to tearing so that if impacted by debris, the sheet is not readily ripped or torn.

The sheet 102 of the pleated sealing tape 100 includes a rear surface 103 and a front surface 104, as shown in FIG. 3. The rear surface 103 of the sheet 102 is at least partially coated with an adhesive 130 so that the pleated sealing tape 100 may be secured to a surface via the adhesive 130. Preferably, the adhesive 130 is applied so that it does not fully cover the rear surface 103 of the sheet 102. As the sheet 102 is pleated, peaks 122 are formed by the pleats 110 on the rear surface 103 of the sheet 102, and the adhesive 130 is applied only to the peaks 122. The troughs 124 formed by the pleats 110 are not covered, or are at least are not fully covered by the adhesive 130. The adhesive 130 is a pressure-sensitive adhesive so that the pleated sealing tape 100 can be applied to and secured to a surface by application of pressure, yet subsequently removed therefrom without damaging the surface or leaving a residue on the surface. The pressure-sensitive adhesive preferably include a natural rubber, a vinyl ether, an acrylic, butyl rubber, a styrene block copolymer, a silicone or a nitrile, and may further include a tackifier, such as a synthetic resin, including terpenes, terpene-phenols or aromatic resins.

The front surface 104 of the sheet 102 may optionally include a coating 140. The coating 140 may fully cover the front surface 104 of the sheet 102, as shown for example in FIG. 8. The coating 140 may be a paint, pigment or colorant to provide the pleated adhesive tape with a desired aesthetic appearance. The coating 140 may also be a waterproofing agent to provide a further waterproofing effect. The coating 140 may alternatively be a UV-protective coating to prevent cracking or discoloration of the adhesive sealing tape when exposed to UV-radiation. The coating 140 may also be a bactericide, fungicide or algaecide in order to kill bacteria, fungi and/or algae to prevent the growth and spread of these contaminants.

Referring now to FIG. 4, there is shown a perspective view of the pleated sealing tape as used to cover a gap between a storm cover and a building. In the illustrated embodiment, a building 300 includes a storm cover 320 positioned over a window 310. The storm cover 320 substantially covers the window 310 and may be secured to the building 300 by mechanical fasteners. The pleated sealing tape 100 of the present invention is positioned over a gap formed between the storm cover 320 and the building 300. The pleated sealing tape 100 can be secured to the surface 301 of the building 300 and the surface 321 of the storm cover 320 by placing the pleated sealing tape 100 in contact with the surfaces and applying pressure. The pressure-sensitive adhesive on the rear surface of the pleated sealing tape 100 secures the pleated sealing tape 100 to the surfaces 301, 321 so that the pleated sealing tape 100 covers the gap. The pleated sealing tape 100 is substantially waterproof so that water, liquid and debris cannot pass through the pleated sealing tape 100 and thus cannot pass through the gap. The pleated sealing tape 100 can be applied in a similar manner around the perimeter of the storm cover 320 to seal all gaps between the storm cover 320 and the building 300.

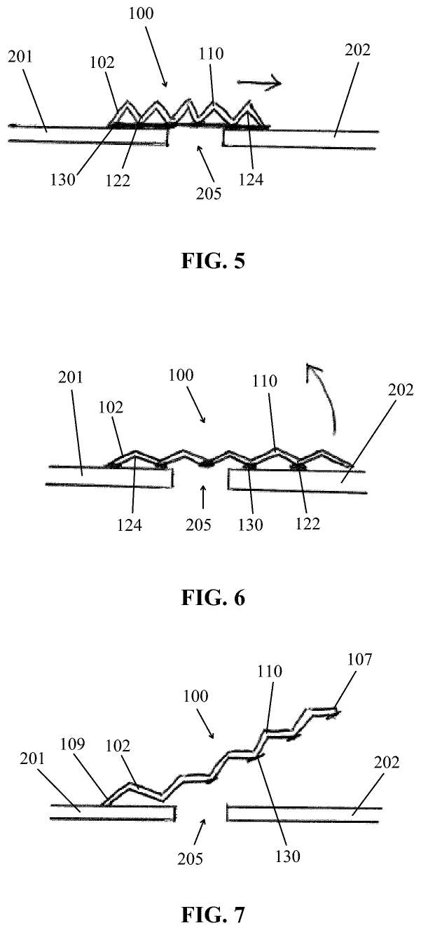

Referring now to FIGS. 5-7, there are shown views of the pleated sealing tape as applied to a surface to cover a gap and at various stages of removal from the surface. In operation, the pleated sealing tape 100 can be positioned over a gap 205 defined between two surfaces 201, 202 that is desired to be covered such that the rear surface 103 of the sheet 102 contacts surfaces 201, 202 on opposing sides of the gap 205. The pleated sealing tape 100 in an unstretched configuration is placed with the rear surface 103 having an adhesive 130 in contact with the surfaces 201, 202. When the pleated sealing tape 100 is secured to the surface 201, 202, the peaks 122 of the rear surface 103 of the sealing tape 100 and the adhesive 130 are in contact with the surfaces 201, 202, and the troughs 124 of the pleats 110 are not in contact with the surfaces 201, 202. In this way, the sheet 102 provides a waterproof covering over the gap 205 between surfaces 201, 202 to prevent dirt and debris from passing through the gap 205. The pleated sealing tape will remain in position until manually removed.

In order to remove the pleated sealing tape 100, the pleated sealing tape 100 can be stretched in a direction transverse to the longitudinal axis of the sheet 102, and thus transverse to the orientation of the pleats 110, as shown in FIG. 6. Preferably, a user may grasp a first side of the pleated sealing tape 100 and pull the first side away from an opposing side of the sheet 102 so as to stretch the sheet 102. As the pleated sealing tape 100 is stretched into a stretched configuration, the pleats 110 flatten so as to expose more of the troughs 124 which lack an adhesive. As the pleated sealing tape 100 is stretched, the peaks 122 are stretched apart and may begin to separate from the surfaces 201, 202. Stretching the sheet 102 helps to break the adhesive connection with the surface while exerting little to no force on the surface. In this way, the stretched sheet 102 can be more easily removed from the surface, as the adhesive connection to the surface is weakened.

With the pleated sealing tape 100 in a stretched configuration, the sheet 102 can then be more easily peeled off of the surfaces 201, 202 than when the pleated sealing tape 100 is in the unstretched configuration. The stretched pleated sealing tape 100 can be progressively peeled away from the surface beginning with the first side 107 of the sheet 102 and moving towards an opposing, second side 109 in a direction transverse to the longitudinal axis of the pleated sealing tape 100. The pleated sealing tape 100 does not damage the underlying surfaces, such as the surface of a building and/or a storm cover. Further, the pleated sealing tape can be removed without ripping or tearing the pleated sealing tape. The pressure sensitive adhesive is selected so as to not leave a residue on the surface to which the pleated sealing tape is applied.

The present invention also relates to methods of forming the pleated sealing tape. The pleated sealing tape may be prepared by forming a flexible sheet from a polymeric material that is substantially waterproof, for example, by the film may be formed by blown film extrusion. The sheet may have one or more layers. When the sheet has multiple layers, the layers are preferably bonded to form a unitary sheet. The sheet can be formed so as to have a desired thickness, such as about 0.02 mm to 2 mm. The sheet can be cut into the desired shape, such as a square or rectangular shape.

The sheet is folded or creased or “creped” so as to form a plurality of pleats. The pleats are preferably formed at an interval of about 0.025 cm to about 0.4 cm. However, the pleats need not be formed at a regular interval, and the interval between successive pleats may vary.

The rear surface of the sheet is at least partially coated with an adhesive for use in securing the pleated sealing tape to a surface. Preferably, the adhesive is a pressure-sensitive adhesive. The adhesive does not fully cover the rear surface of the sheet, and the adhesive is preferably applied to the peaks formed by the pleats on the rear surface of the sheet. In some embodiments, the coating may be applied by roll coating or by spray coating.

In some embodiments, the adhesive coating is covered with a release film, such as a silicone film, that is easily removable when one wishes to apply the sealing tape.

A coating may be applied to the front surface of the sheet. The coating may be any of a pigment, colorant, UV-protective agent, or waterproofing agent, among other coatings.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A pleated sealing tape for providing a waterproof and/or watershedding covering, comprising:
a flexible sheet comprising a polymeric material and having a plurality of pleats extending from a first end of the sheet to an opposing end of the sheet, and further comprising a front surface and a rear surface;
wherein the rear surface of the sheet comprises a pressure-sensitive adhesive, and wherein when the sheet is applied to a surface, the sheet is configured to be removed from the surface by stretching the sheet in a direction transverse to the orientation of the plurality of pleats and subsequently peeling the sheet away from the surface.

2. The pleated sealing tape of claim 1, wherein the sheet has a thickness of about 0.02 mm to about 2 mm.

3. The pleated sealing tape of claim 1, wherein the polymeric material is selected from polyethylene, polyvinylchloride, polypropylene, polyurethane, and acrylonitrile-butadiene styrene (ABS).

4. The pleated sealing tape of claim 1, wherein each of the plurality of pleats are substantially parallel to a longitudinal axis of the sheet.

5. The pleated sealing tape of claim 1, wherein the plurality of pleats are separated by an interval of about 0.025 cm to about 4.0 cm.

6. The pleated sealing tape of claim 1, wherein the rear surface of the sheet comprises a plurality of peaks formed by the plurality of pleats, and the pressure-sensitive adhesive is applied to the plurality of peaks.

7. The pleated sealing tape of claim 1, wherein the pressure-sensitive adhesive comprises a natural rubber, a vinyl ether, an acrylic, butyl rubber, a styrene block copolymer, a silicone or a nitrile.

8. The pleated sealing tape of claim 1, wherein the front surface of the sheet comprises a coating.

9. The pleated sealing tape of claim 1, wherein the sheet comprises two or more layers.

10. A method for temporarily covering a gap formed between two surfaces, comprising:
providing a pleated sealing tape comprising a flexible sheet that comprises a polymeric material and a plurality of pleats extending from a first end of the sheet to an opposing end of the sheet, and further comprising a front surface and a rear surface, wherein the rear surface of the sheet comprises a pressure-sensitive adhesive;
positioning the pleated sealing tape over a gap defined between two surfaces; and
affixing the pleated sealing tape to the two surfaces defining the gap to secure the pleated sealing tape to the surfaces.

11. The method of claim 10, wherein affixing the pleated sealing tape comprises pressing the rear surface of the pleated sealing tape into contact with the two surfaces.

12. The method of claim 10, further comprising:
removing the pleated sealing tape by stretching the pleated sealing tape in a direction transverse to the orientation of the plurality of pleats and subsequently peeling the pleated sealing tape away from the two surfaces in a direction transverse to the orientation of the plurality of pleats.

13. A method of removably affixing a tape on a surface comprising providing a pleated sealing tape comprising a flexible sheet that comprises a polymeric material and a plurality of pleats extending from a first end of the sheet to an opposing end of the sheet, and further comprising a front surface and a rear surface, wherein the rear surface of the sheet comprises a pressure-sensitive adhesive; positioning the pleated sealing tape over a gap defined between two surfaces; and affixing the pleated sealing tape to the two surfaces defining the gap to secure the pleated sealing tape to the surfaces, wherein the tape protects the surface to which it is applied from direct water exposure.
